(19) United States
(12) Patent Application Publication
(10) Pub. No.: US 2004/0148271 A1
(43) Pub. Date: Jul. 29, 2004

(54) System and method for defining and processing decision processes

(76) Inventor: Stephen Wood, Bristol (GB)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/352,191

(22) Filed: Jan. 28, 2003

(51) Int. Cl. G06F 7/00

(52) U.S. Cl. 707/1

(57) ABSTRACT

A system and method for defining and processing decision processes. Decision processes are modeled using decision process objects corresponding to questions, choices, user inputs, decisions, formulae, conclusions, and analysis summaries, for example. These objects are used to build design templates, which are visual representations of the decision processes that indicate the flow of steps thereof, and through which decision processes can be deployed to a computing application for subsequent use.

### FIELD OF THE INVENTION

The present invention relates generally to computer-based knowledge systems and more particularly to a system and method for defining and processing decision processes.

### BACKGROUND OF THE INVENTION

Businesses and their staff typically provide knowledge to individuals and entities both within and outside of their organization for a variety of purposes. Often, this knowledge is definable, and provided on a repeated basis. In this context, knowledge is considered “definable” if a process can be defined (also referred to herein as a “decision process”) that describes what knowledge is to be provided by a knowledge provider under certain conditions. Put another way, knowledge providers very rarely impart knowledge without some initial prompting. The decision process describes how a knowledge provider may be prompted for specific knowledge, and what specific knowledge should be imparted to others when so prompted. This knowledge can be extremely valuable and may adversely affect the organization if the knowledge “leaves” (e.g. through staff changes) or is confused (e.g. inconsistent decisions are made by similar knowledge providers).

For example, a customer service employee of an organization may have been trained to provide certain information to members of the public. In determining what specific information should be provided in any given situation, the employee may perform a series of steps of a process that is followed and used to decide how a problem should be identified and the appropriate solution to be recommended. In some cases, this process may be based on an established procedure defined by the organization. However, in other cases, this process may be undocumented, and one that the employee is using because, for example, the employee has discovered from past experience that the process is satisfactorily effective.

Even where the process used may be based on an established procedure, a particular situation may not be addressed by the procedure, in which case the employee may be required to improvise in the providing of information.

Since knowledge provided by knowledge providers is often undocumented, decisions made based on that knowledge might be inconsistent and made without adequate justification and auditing. For instance, different estate agents can give widely different valuations even though collectively, they may all be considered to be experts in their field.

Accordingly, there is a need for systems and methods for documenting the decision processes of knowledge providers that may be used to provide such knowledge in a more predictable and consistent manner.

### SUMMARY OF THE INVENTION

The present invention relates to a system and method for defining and processing decision processes.

In one aspect of the invention, there is provided a method of defining and processing a predetermined decision process comprising a plurality of steps, the method comprising the steps of: (a) generating a design template for said decision process, wherein said design template is a visual representation of said decision process generated by a first computing application; and (b) processing said decision process, wherein a second computing application is adapted to execute said decision process as represented by said design template.

In another aspect of the invention, there is provided a system for defining and processing a predetermined decision process comprising a plurality of steps, the system comprising: (a) a first computing application adapted to generate a design template, wherein said design template is a visual representation of said decision process; and (b) a second computing application adapted to receive instances of said design template and process said decision process, wherein said decision process is executed as represented by said design template.

In another aspect, instructions for performing the steps of a method of defining and processing decision processes in an embodiment of the present invention may also be stored on a computer-readable medium.

### BRIEF DESCRIPTION OF THE DRAWINGS

For a better understanding of the present invention, and to show more clearly how it may be carried into effect, reference will now be made, by way of example, to the accompanying drawings in which:

FIG. 1 is a schematic diagram of a system for defining and processing decision processes in an embodiment of the present invention;

FIG. 2 is a screen capture illustrating an example of an interface of a designer application in an embodiment of the present invention;

FIG. 3 is a screen capture illustrating an example of an initial screen displayed by a client application in an embodiment of the present invention;

FIG. 4A is a screen capture displayed by a designer application illustrating an example of a question definition form used to define a question object of a decision process in an embodiment of the present invention;

FIG. 4B is a screen capture displayed by a designer application illustrating an example of a choice definition form used to define a choice object of a decision process in an embodiment of the present invention;

FIG. 4C is a screen capture displayed by a designer application illustrating an example of a condition definition form used to define a condition object of a decision process in an embodiment of the present invention;

FIG. 4D is a screen capture displayed by a designer application illustrating an example of a user input definition form used to define a user input object of a decision process in an embodiment of the present invention;

FIG. 4E is a screen capture displayed by a designer application illustrating an example of a formula definition form used to define a formula object of a decision process in an embodiment of the present invention;

FIG. 4F is a screen capture displayed by a designer application illustrating an example of a summary definition form used to define a summary object of a decision process in an embodiment of the present invention;

FIG. 4G is a screen capture displayed by a designer application illustrating an example of a conclusion definition form used to define a conclusion object of a decision process in an embodiment of the present invention; and

FIG. 5 is a flowchart illustrating the steps of a method of defining and processing decision processes in an embodiment of the present invention.

### DETAILED DESCRIPTION OF THE INVENTION

The present invention is generally directed to a system and method for mapping knowledge in the form of decision processes into software. Decision processes are broken down into decision process objects that are used to build visual representations or models of the decision processes, which can then be deployed in a computing application. Results obtained from the use of the computing application may subsequently be analyzed for reporting purposes, and/or to refine the models of the decision processes, for example.

In one embodiment of the invention, a decision process can be defined as a set of questions, choices, user inputs, conditions, and formulae, which may then be subsequently used to generate a conclusion (or set of conclusions) and/or an analysis summary. The above listed items are provided as examples of decision process objects with which the decision process can be modeled, and which interact to define a flow of steps in the decision process that can be followed in providing knowledge in accordance with that decision process.

In accordance with the present invention, a design template for the decision process is generated before the decision process is deployed for subsequent use. A design template is a visual representation of a decision process that indicates the flow of steps in the decision process. Users of designer applications programmed to permit the generation of design templates are generally required to build design templates using only design elements corresponding to decision process objects from a pre-defined set thereof.

Instances of a design template are received by client applications for processing. After a decision process is deployed through a client application in this manner, the decision process is processed by the client application. Steps of the decision process are performed, and input received from users of the client application are analyzed and used to determine, in real-time, which particular steps should be performed and what knowledge or information is to be disseminated to the users accordingly. Accordingly, instances of a design template, when deployed, implement the decision-making flow control represented by the decision process. Further analysis of the input provided by those users using customized tools can also be performed.

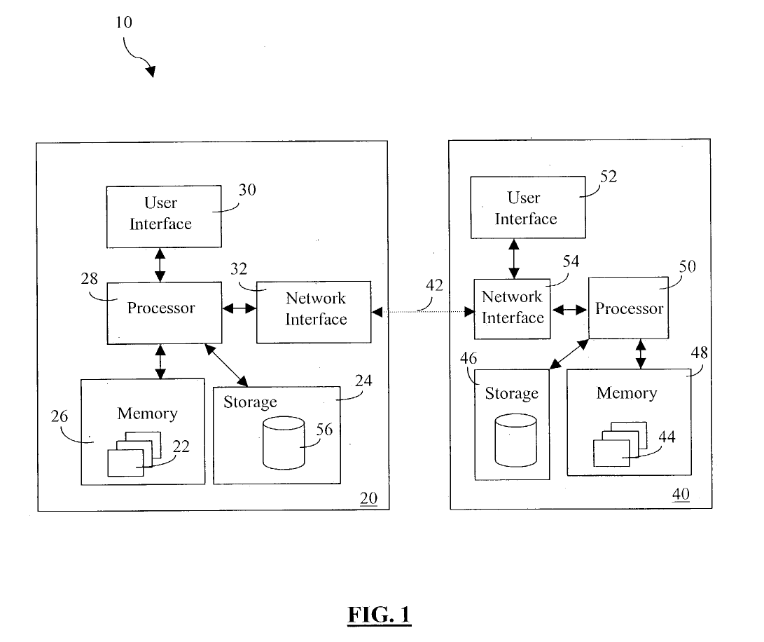

Referring to FIG. 1, a schematic diagram of a system for defining and processing decision processes in an embodiment of the present invention is shown generally as 10.

System 10 comprises a first computing application (also referred to herein as a designer application) for execution on a first computing device 20 (also referred to herein as a designer machine). The designer application is implemented as a set of programming modules 22, which are loaded from a storage device 24 (e.g. a hard disk) into memory 26 for processing by a processor 28.

Designer machine 20 also comprises a user interface 30 through which output is displayed to users of the designer application, and through which input from those users is received. A user of the designer application is also referred to herein as a designer. Designer machine 20 also comprises a network interface 32 coupled to processor 28. Network interface 32 is adapted to facilitate communications between components of designer machine 20 and those of a second computing device 40 (also referred to herein as a client machine) over a network coupling 42. In some network configurations, designer machine 20 may be considered to be a server.

Client machine 40 comprises a second computing application (also referred to herein as a client application) implemented as a set of programming modules 44, which are loaded from a storage device 46 (e.g. a hard disk) into memory 48 for processing by a processor 50. Client machine 40 also comprises a user interface 52 through which output is displayed to users of the client application, and through which input from those users is received. A user of the client application is also referred to herein as a client application user. Client machine 40 also comprises a network interface 54 coupled to processor 50.

Input received from client application users may be stored in a database 56. In this embodiment of the invention, this input is transmitted from client machine 40 to designer machine 20 over network coupling 42 for storage in database 56, which resides on storage device 24 of designer machine 20. This input may then be processed and analyzed for reporting to designers.

It should be noted that the above description of system 10 relates to one embodiment of the invention, and that other architectures and arrangements may be implemented in variant embodiments of the invention. For example, it is not necessary that designer machine 20 be coupled to a network, nor is it necessary that client machine 40 be coupled to a network. In one embodiment of the invention, designers may save data input to or generated by the designer application (e.g. design templates as described herein) to a portable storage device (e.g. floppy disk, compact disc, etc.) as a file, which would then be copied to storage device 46 or loaded into memory 48 of client machine 40 for use by the client application. Data input to or generated by the client application may also be save to a portable storage device as a file, which would then be made accessible to designer machine 20.

As indicated above, a design template for a decision process is generated before the decision process is deployed for use. In an embodiment of the present invention, the designer application referred to in respect of FIG. 1 is programmed to permit designers to generate design templates.

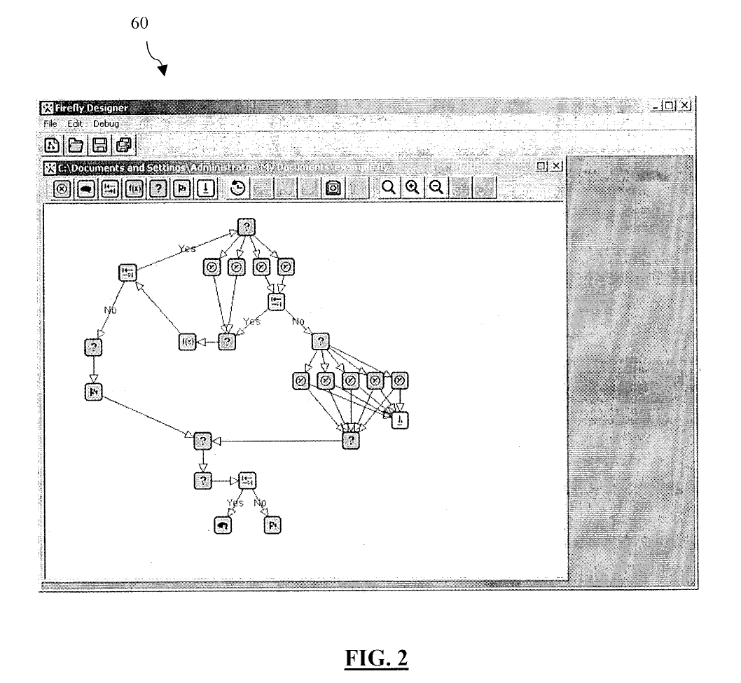

Referring to FIG. 2, a screen capture illustrating an example of an interface of a designer application in an embodiment of the present invention is shown generally as 60. The designer application is a visual tool that allows knowledge providers to map knowledge and the manner in which it is to be imparted to client application users into software using simple flow diagrams, by creating a design template. More specifically, the design template is a visual representation of a decision process that is made up of a number of design elements, most of which are associated with decision process objects of the decision process, such that the design template indicates a flow of steps of the corresponding decision process. Put another way, the design template is a map, which provides all possible flow paths through the steps of its associated decision process.

In this embodiment of the present invention, the design elements of a design template are decision flow objects, which appear as flow chart symbols when displayed to users of the designer application. In this manner, decision flow objects can be connected into a flow diagram that is used to model the steps of the decision process. The designer application is adapted to permit designers to create, move and delete decision flow objects and to edit flow connections therebetween. In one implementation of this embodiment of the present invention, designers can “drag-and-drop” objects within a virtual workspace provided the designer application. The designer application may also be adapted to provide “active validation”, in that the flow connections between decision flow objects and the definitions of decision flow objects are checked to ensure their validity (as defined in the designer application) as changes are made to the design template.

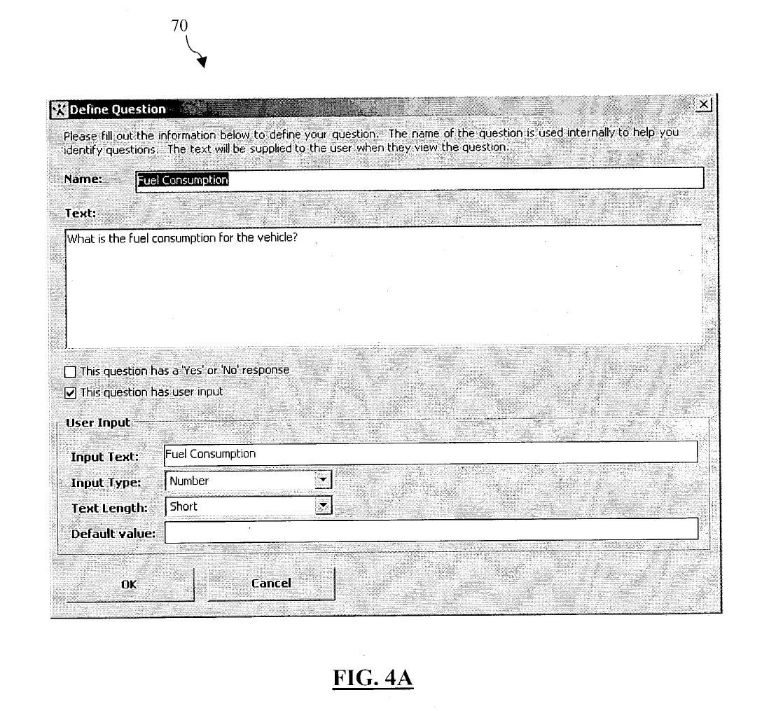

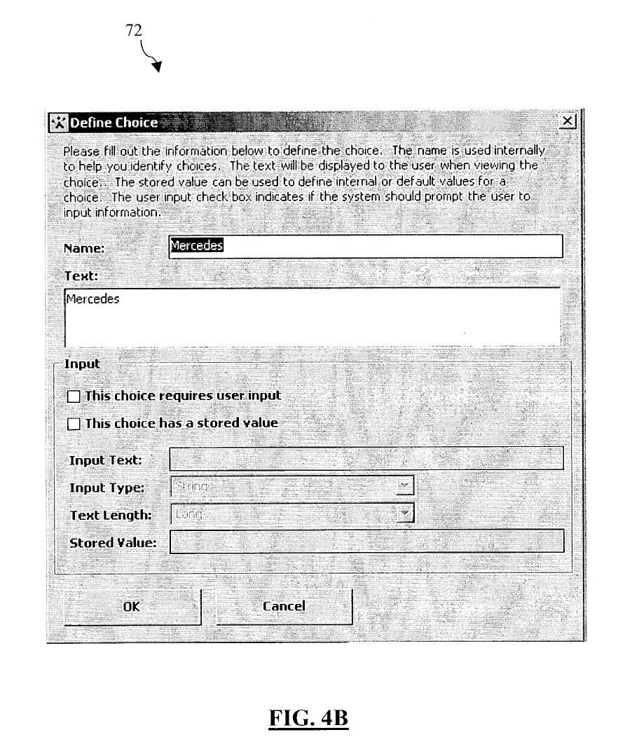

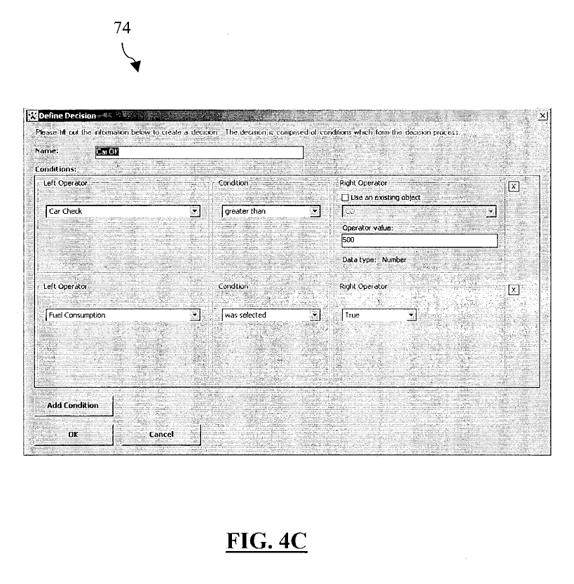

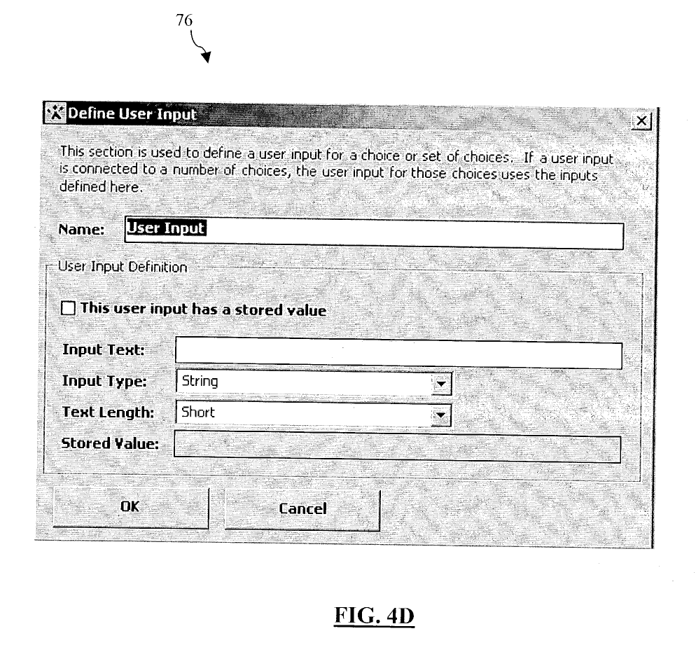

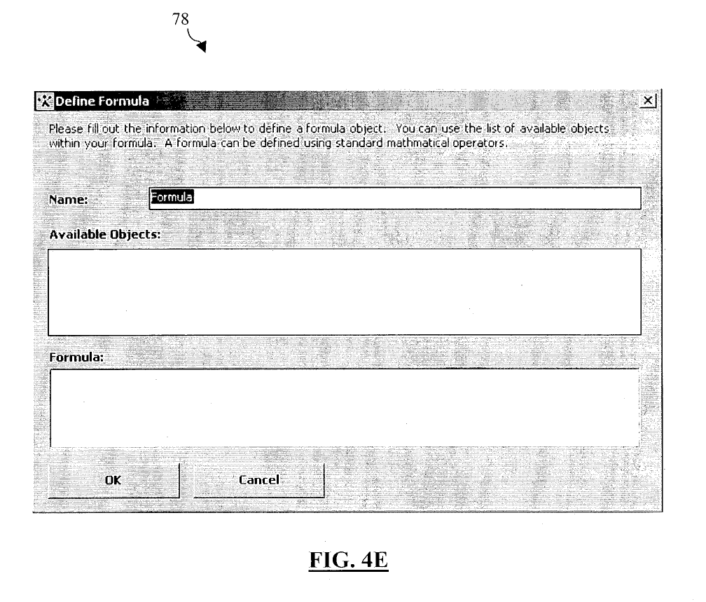

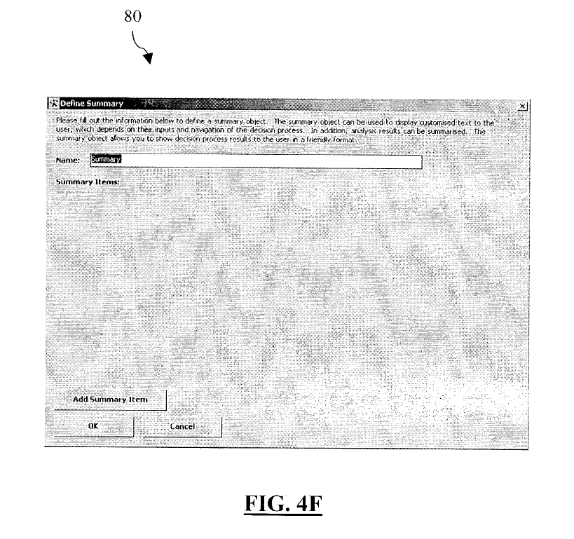

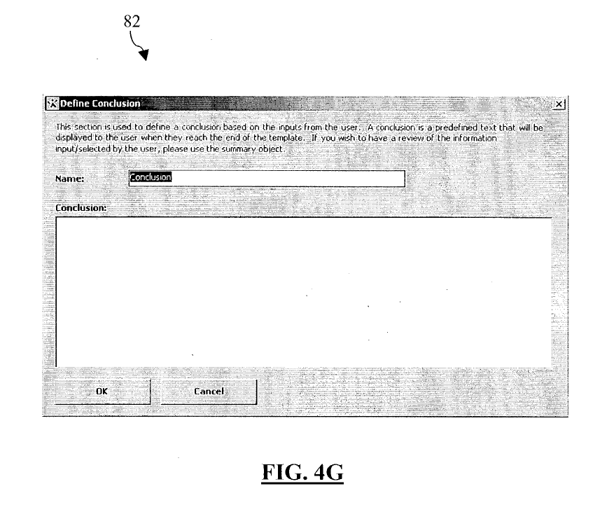

Examples of different decision process objects that can be used in defining a decision process and which are modeled as a flow diagram using a design template of design elements will be described in further detail below with reference to FIGS. 4A to 4G. In one embodiment of the present invention, there is a one-to-one association between a decision flow object of a design template and a decision process object of the corresponding decision process. Accordingly, each step in the decision process would be represented by a single flow chart symbol in the visual representation of the decision process. However, this association is not essential and can differ in variant embodiments of the invention. For example, in variant embodiments of the invention, a designer application may be programmed to permit designers to group multiple decision process objects and save the group as a user-defined type. The designer could then add this group as a single visual object, which may be used to represent a micro decision process.

In one embodiment of the present invention, design templates are saved as data in files based on an Extensible Markup Language (XML), to be read by client applications. This can facilitate the generation of reports using numerous industry standard reporting tools (e.g. Crystal Decisions, Inc.'s Crystal Reports). In variant embodiments of the invention, the designer application may be adapted to save design templates and other data in other formats, as may be known to persons skilled in the art.

In one implementation of an embodiment of the present invention, the designer application is programmed in accordance with an object-oriented paradigm, and the design templates themselves are modular and may be constructed of different objects of various similar types. This may provide designers with considerable flexibility in the modeling of decision processes and the nature of the data that may be obtained from users of client applications through which decision processes are deployed.

After a design template is generated using the designer application that is executed on a designer machine (e.g. designer machine 20 of FIG. 1), the associated design process is then delivered or deployed to users of a client application as an instance of the design template, in an embodiment of the present invention.

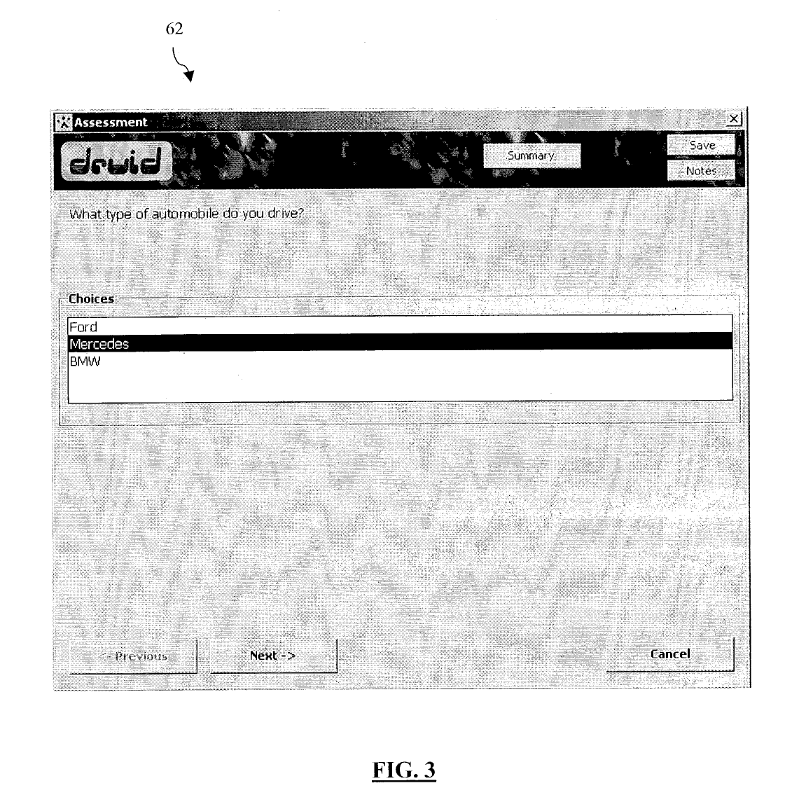

Referring to FIG. 3, a screen capture illustrating an example of an initial screen displayed by a client application in an embodiment of the present invention is shown generally as 62. In the processing of a decision process, the client application appears to client application users as a simple wizard or expert system, and is programmed to perform the steps of the decision process in accordance with the flow indicated by the design template associated therewith. In processing the decision process, output is displayed to client application users, client application users are prompted for input, and input is received from client application users, in order that appropriate knowledge underlying the decision process is imparted to those users as may be defined by that decision process.

The client application may be designed to be platform independent, designed to be executable on different systems (e.g. Unix™, Linux™, or Windows™ based systems) and on different types of computing devices (e.g. desktop computers, laptop computers, personal digital assistants, etc.). It is also preferably adapted to allow integration with other software applications (e.g. Microsoft Corporation's Excel™, Project™, or Word™ applications) through the use of simple application programming interfaces in its design.

A decision process may be deployed to client application users by transmitting an instance of the associated design template to one or more computing devices. In one embodiment of the invention, the decision process in the form of a client application is distributed as a file, either by electronic mail or using a disconnected storage means (e.g. a floppy disk or compact disc) to one or more client application users. The client application can then be loaded for execution on a client machine (e.g. client machine 40 of FIG. 1).

In another embodiment of the invention, the decision process is published to multiple users of the client application, which may reside on different computing devices in a network. Changes to the design template being made by a designer at a designer machine may be automatically propagated to the different client machines for use, or propagated after a specified period or subject to the occurrence of a specified event (e.g. approval by a third party). The designer application may also be adapted to permit designers to control access to published decision processes on the network.

In another embodiment of the invention, the design templates are web-based, and the decision process is published to multiple client application users through a customized web site in which updates are automatically displayed in the web browser of each client application user, as desired.

It will be understood by persons skilled in the art that the features of the various deployment techniques described above need not be mutually exclusive, and accordingly, any given implementation of the present invention may be capable of deploying decision process in accordance with all or some of the described techniques.

Examples of different decision process objects that can be used in defining a decision process will now be described in further detail with reference to FIGS. 4A to 4G.

Referring to FIG. 4A, a screen capture displayed by a designer application illustrating an example of a question definition form used to define a question object of a decision process in an embodiment of the present invention is shown generally as 70.

Instances of a question object represent questions that will be posed to a client application user in order to obtain information that may be subsequently used in determining what knowledge the client application will provide to that user in accordance with the decision process. For example, the knowledge provider may want users of the client application to be prompted to make a simple choice, which when made, provides routing information (i.e. defines the path to be followed) through the flow of steps of the decision process. Further questions may then be posed to applications users for more detailed information.

Designers define questions by setting the properties of question objects using a question definition form 70. Question definition form 70 allows designers to specify the text that will be displayed to client application users, and to decide if the question is to have a simple “Yes/No” answer, and/or to request other input from the client application user. Input from client application users can be of a pre-defined data type (e.g. date, number, text, etc.), as well as a length (e.g. short, long, etc.) that may be used to define the size of an input entry box that would be displayed to client application users. Designers may also choose to specify a default value for an entry field and/or provide additional explanatory text that would be displayed to client application users, either on the input form or in a different frame or window accessible on the selection of a button or link, for example.

For example, one or more “help” screens may be associated with each question. Designers specifying a question can define an associated help index entry, which client application users may access by pressing a specified button (e.g. a button provided on the form, or a button on the keyboard such as “F1”) or link. Text of the defined help index entry can then be displayed to client application users, by way of a separate window, dialog box, or caption for example.

Question objects are polymorphic, meaning that they change in behaviour depending on how they are used. In one embodiment of the invention, a given question object may take on one of the following states, for example:

(a) Simple question: A simple question is one that has no user input. It is simply a question with a list of choice for the user to make a selection. As a result, designers must connect decision flow objects associated with choice objects (described below with reference to FIG. 4B) to decision flow objects associated with the question object. Otherwise, the question is not complete, as the manner in which a value corresponding to an answer to the question is undefined. A designer application may be adapted to ensure that sufficient connections are made if the design template is to be considered a valid representation of the associated decision process.

(b) Question with Yes/No response: The question acts like a condition (described below with reference to FIG. 4C) because when a designer connects the decision flow object associated with the question object to other decision flow objects, only two flow connectors flowing out of the corresponding question object may be used. One connector will represent the path segment to be followed upon receiving a “Yes” answer from a client application user, while the other connector will represent the path segment to be followed upon receiving a “No” answer from a client application user. A designer application may be adapted to ensure that the two connections are made if the design template is to be considered a valid representation of the associated decision process.

(c) Question with user input: The question cannot have choices and can be directly connected to other decision process objects as may be defined by the designer application.

Referring to FIG. 4B, a screen capture displayed by a designer application illustrating an example of a choice definition form used to define a choice object of a decision process in an embodiment of the present invention is shown generally as 72.

Instances of a choice object represent choices that are to be made by a client application user, and that may be subsequently used in determining what knowledge the client application will provide to that user in accordance with the decision process. A choice object can be defined for use in conjunction with a defined question object, and cannot exist on its own. Through the use of choice objects, client application users are provided with a set of values from which they must make a selection. In one example implementation, only one choice may be selected. However, in general, a selection may constitute multiple choices so long as the designer is able to define a path through the decision process on which to continue for each of all possible user selections.

Designers define choices by setting the properties of choice objects using a choice definition form 72. Choice definition form 72 allows designers to specify how client application users are to be prompted to make the choice. Client application users may also be prompted for additional input (e.g. if a client application user selects “Other”, that user may be to provide additional details). Unlike question objects, instances of choice objects may be adapted to display a value to client application users that is different from the value stored in them. This allows designers to specify, for example, that qualitative values be displayed even though a quantitative result is stored (e.g. “High” might have a stored value of 5, which can be used in subsequent calculations, conditions, and reporting analysis, for example).

Referring to FIG. 4C, a screen capture displayed by a designer application illustrating an example of a condition definition form used to define a condition object of a decision process in an embodiment of the present invention is shown generally as 70.

A condition object allows the user of the designer application to introduce conditions and analysis in modeling the decision process. Instances of a condition object represent conditions that, when evaluated, may be subsequently used in determining what knowledge the client application will provide to that user in accordance with the decision process. Designers define conditions by setting the properties of condition objects using a decision definition form 74. A condition may be used to compare any previously used decision process object or one or more values associated therewith with some other decision process object or value. For example, the comparison may be between values (e.g. values stored in a particular decision process object, values input from client application users, values resulting from the evaluation of a formula, and predefined or default values), or the comparison may represent a query of whether a particular decision process object was “used” (e.g. was a particular client application user asked a particular question). Conditions may be defined that represent the following statements, for example: “Was the blood pressure entered by the client application user greater than their cholesterol level”; and “Was the result of the torque ratio formula equal to the specified horse power for this model of car”. Multiple conditions can be embodied in an instance of a condition object, so long as the instance of the condition object may be evaluated to a value.

In one embodiment of the invention, each condition is evaluated to either a value of “true” or “false”. In this embodiment, once a condition object is defined, the corresponding decision flow object is typically connected to two other decision flow objects, one representing the next step in the flow of decision process steps when the condition is evaluated to a “true” value and the other representing the next step in the flow of decision process steps when the condition is evaluated to a “false” value. In variant embodiments of the invention, conditions may be defined in a different manner, where each condition may be evaluated to a different set of values, and where each condition may be evaluated to a different number of values.

Referring to FIG. 4D, a screen capture displayed by a designer application illustrating an example of a user input definition form used to define a user input object of a decision process in an embodiment of the present invention is shown generally as 76.

Instances of a user input object represent a definition of specific input that is to be obtained from a client application user. This input may be subsequently used in determining what knowledge the client application will provide to that user in accordance with the decision process. Instances of user input objects can be defined for use in conjunction with defined choice or question objects, for example. More specifically, user input objects are used to define a generic user input across multiple choices, or to provide a single container for user inputs across different questions and choice sets.

For example, if a value is required from a client application user, that value may be obtained in a variety of ways, either through user input as part of a question or user input as part of a choice in this embodiment of the invention (e.g. the question might be “What is your name?” and the designer would create a question object that has user input; or the question might be “What is your favorite car?” and the designer may provide a number of choices such as “Ford™”, “Mercedes™”, “BMW™” and “Other”, and specify that the “Other” choice has user input so if it selected, the application is prompted to specify the answer to the question). However, instead of defining user input in this manner, a user input object could be defined and attached to one or more question or choice objects so that the designer need only explicitly define the form of the required user input once. Therefore, if the designer wishes to obtain a value of a rating from 1 to 10 for each of a list of choices (represented by a set of choice objects), a user input object representing a 1-10 rating may be attached to each choice object.

Accordingly, user input objects may be defined for convenience, speed of deployment, and to more clearly define allowable user responses. Designers define user input for this purpose by setting the properties of user input objects using a user input definition form 76.

Referring to FIG. 4E, a screen capture displayed by a designer application illustrating an example of a formula definition form used to define a formula object of a decision process in an embodiment of the present invention is shown generally as 78.

Instances of a formula object represent formulae that are to be evaluated, and that may be subsequently used in determining what knowledge the client application will provide to a client application user in accordance with the decision process. Formula objects are defined to allow designers to process and analyze numerical user inputs. Designers define formulae by setting the properties of formula objects using a formula definition form 78. Formulae can be defined using standard mathematical operators, and can include constants and values of previously entered user input in their evaluation, for example. The result of a formula can then be used in the evaluation of other decision process objects.

Referring to FIG. 4F, a screen capture displayed by a designer application illustrating an example of a summary definition form used to define a summary object of a decision process in an embodiment of the present invention is shown generally as 80.

Instances of summary objects can be defined to allow designers to define specific outputs for display to client application users. Designers define summaries (also referred to herein as analysis summaries) by setting the properties of summary objects using a summary definition form 78. A summary may be a list displaying values previously input by client application users, for example. When processed, a summary object may also indicate that text that incorporates previously obtained user inputs and results of previous analyses is to be displayed to client application users., For example, a summary may comprise a few paragraphs of text, which incorporate responses provided by the user, as well as the results of processed formulae and decisions.

Although summaries are often used as terminators of decision processes, they can also represent an intermediate step in a decision process, where further information may be obtained after their display. For example, a summary might make a recommendation, after which the client application user may be prompted for additional information pertaining to actions performed after the recommendation was made.

Referring to FIG. 4G, a screen capture displayed by a designer application illustrating an example of a conclusion definition form used to define a conclusion object of a decision process in an embodiment of the present invention is shown generally as 82.

Conclusion objects represent a simpler implementation of summary objects in that they provide text stating a conclusion to a decision process. This text is “hard-coded” into the design template and does not incorporate user data or analysis results. Designers define conclusions by setting the properties of conclusion objects using a conclusion definition form 82.

Although conclusions are often used as terminators of decision processes, they can also represent an intermediate step in a decision process, where further information may be obtained after their display, for example. For example, a conclusion may be used as a direction to a client application user to perform some action and then to return to the client application once the action has been completed and a result has been achieved. The details of the action and the results may then be submitted as part of the decision process.

Other Decision Process Objects

Other decision process objects may also be defined. For example, category and section objects may be used, as described below. However, these decision process objects and the other decision process objects described herein are provided as examples only; other decision process objects may be defined and utilized in variant embodiments of the present invention.

(a) Category objects: Instances of a category object represent categories that may be subsequently used in determining what knowledge the client application will provide to that user in accordance with the decision process. Instances of a category object can be defined for use in conjunction with list importing (i.e. the category allows the designers to group list of items into categories). Certain choice objects may be used to provide users of the client application with a list of products or services, for example. These products or services can be divided into one or more categories, and the path of flow through the steps of the decision process may change based on the category selected. More generally, the category object defines which of multiple list items falls into which of a number of pre-defined categories, which may-determine the path of flow through steps of the decision process based on the category selected, rather than on the selection of a specific item. For example, although a client application user may actually select a specific choice, the client application will use the category to which the selected choice belong to determine the next step in the flow of decision process steps.

(b) Section Objects: Instances of section objects can be used for dividing the flow of the decision process into separate decision areas. This may be particularly useful if a client application user may need to perform some external action after completing a section of the decision process before continuing with further steps. Intuitively, the use of section objects allow a decision process to be broken down into “chapters”, and the flow through various steps of a decision process may be commenced at different points. By sectioning the decision process into chapters, a designer can require that all steps of a section of a decision process be performed before steps of other sections may be performed, or that sections of steps be performed in a particular order. Furthermore, section objects make it easy to continue the performance of steps of a decision process from varying points, which can be particularly useful when the decision process is long and complex.

Other Design Considerations

Other functions in a designer application may also be made available to designers to control the flow through steps of a decision process, or to further specify input to and output by the application. For example:

Designers can incorporate loops into design templates and specify limited parameters of a decision process for iterations. For example, if a user is required to perform a decision process segment until they meet a certain condition, the text of the question can alter to recognize the looping.

Designers can integrate object values into displayed text (i.e. designers can add the value of any decision process object to displayed text. For example, a question might display the text “You have said that you have 5 bedrooms in your house, do you use them all?”, where the user had entered 5 to an earlier question about the number of rooms in their house.

Once the design is completed, designers must set a “start question” for the decision process, which is an entry point that is defined to indicate a step from which the flow of steps in the decision process are to be performed (i.e. at which point the flow diagram should be entered). In one embodiment of the invention, one initial entry point is defined and section objects may be used to re-enter the flow of decision process steps at different points.

Designer applications can be adapted to provide debugging tools that allow designers to walk through the different paths of the decision process. The debugging tools are implemented as predefined methods and algorithms that can be programmed to highlight each object in the visual representation of the decision process as it is processed (e.g. “You are here” functionality). The debugging tools may also be programmed to check that any generated design template is valid (e.g. all paths can be traversed, there are no conditions which conflict, etc.).

Designers may specify security and tracking features that restrict the use of deployed decision processes. This may be done to restrict access, and to tag decision process results with a particular user, for example. Designers may also allow a generic login for restricted, but confidential, user executions of a decision process.

Data Acquisition and Analysis

In one embodiment of the invention, data input from client application users and data generated by client applications can be transmitted for storage in a central database (e.g. database 56 of FIG. 1). In one embodiment of the present invention, this data may be saved in files based on an Extensible Markup Language (XML). This can facilitate the generation of reports (which can be generated in various formats including Portable Document Format (PDF), for example) using numerous industry-standard reporting tools (e.g. Crystal Decisions, Inc.'s Crystal Reports). In variant embodiments of the invention, the data may be saved in other formats as may be known to persons skilled in the art. The data may also exported to a different application (e.g. a third party application that is compatible with the client application) for reviewed by users thereof, and in these instances, data need not necessarily be returned for storage in the central database. Where the database resides on a remote computing device, data may be transmitted from a client machine to the remote computing device for storage by electronic mail (and subsequently imported into a designer application, for example). This may be done in response to a user instruction (e.g. save), or alternatively, data may be transmitted for storage automatically in real-time without requiring user interaction.

Once the data is captured in a central database, the data can be used to generate a variety of reports using industry standard reporting tools. In an embodiment of the present invention, the designer application may also provide functionality to view the data in a number of custom ways that can assist designers with process analysis, as follows:

Data received from client application users are compiled to mark various paths on a visual representation of a decision process. For example, the most popular paths traversed through the use of a client application by a collection of users may be marked in red and the least popular paths marked in blue. Other color schemes are possible. In addition to the color-coding, a frequency identifier can be associated with each path or segment thereof that indicates the amount that path or segment has been traversed (e.g. as a percentage) and displayed to designers or other interested users.

Data received from client application users are compiled to calculate a response time between a pair of decision objects (though not necessarily adjacent). Response times between decision objects may be computed by associating with a time stamp with selected decision objects as they are processed. The time stamps may then be stored in a central database. The stored information can be filtered to report on any given time interval. For example, as a client application user proceeds through the steps of a decision process, each time that client application user clicks on “Next” or “Previous” buttons, all of the information displayed with any user input is “stamped” with a date and/or time. When the client application user has completed the steps of the decision process, a set of records for that session (each with an associated time stamp) will have been generated. This could be used to generate, for example, a report comparing the manner in which the steps of a decision process were navigated one year ago to the manner in which they are presently navigated. The report may be used to see how policy within an organization has altered the way its staff execute a particular decision process. As a further example, average response times may be displayed to designers or other interested users on the connectors between each object on the visual representation of the decision process. This feature may be particularly useful if a conclusion has been displayed with a request that the client application user perform some action before continuing. Actions performed within a decision process may accordingly be monitored for bottlenecks.

Designer applications may also be adapted to permit designers to retrieve analysis results or input of a client application user at any time. This may be particularly useful if there is a dispute as to the decisions undertaken at a particular time during the processing of a decision process. The results may even be compared with those obtained with respect to other users. This may be done, for example, by assigning the processing of a decision process (which may also be referred to as an “interview”) a unique identifier and the date and time of its execution or completion. This interview date/time information may then be used to retrieve historical data to be compared with other interviews performed at that time.

In view of the above, different types of reports may be generated upon analyzing the data. For example, a report may be generated that reports on the time taken to move from one decision process object to the next (not necessarily adjacent) within the flow of steps of the decision process. This facilitates a computing of how long it takes between specific events of interest (e.g. between a step where a recommendation is given and a subsequent step where the decision process restarts after an action item is performed by a client application user). As the processing of a decision process may be stopped, saved, and restarted, this report may be useful in isolating potential bottlenecks in the organization. As a further example, information relating to the processing of a decision process by multiple client application users can be used to generate a report on the average time it takes a client application user to perform each step in the decision process. Additionally, an organization could use historical data to see how long it takes for steps of the decision process to be completed due to use of a client application by client application users both before and after the client application users are trained. This may provide an indication of the effectiveness of an organization's training methods.

As data is captured and may be analyzed by designers on an ongoing basis, the designers can review decision processes and periodically update them to provide a better mapping. This allows decision processes to be fine-tuned. The updated decision processes are then re-deployed to client application users.

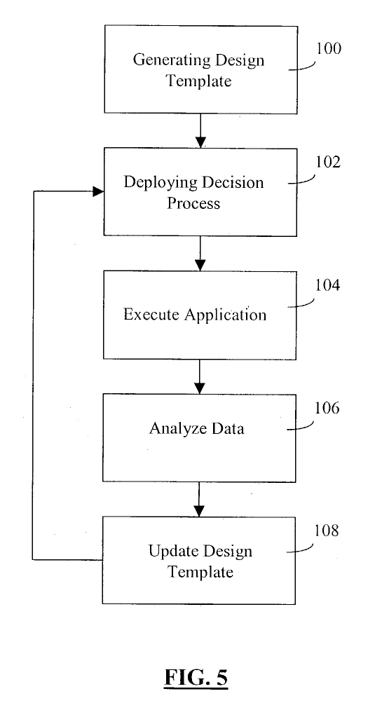

Referring now to FIG. 5, a flowchart illustrating the steps of a method of defining and processing decision processes in an embodiment of the present invention is provided.

At step 100, the design template for a pre-determined decision process is generated. As indicated earlier, the design template is a visual representation of the decision process that can be displayed to designers. The steps of the decision process are modeled using a set of pre-defined decision process objects, examples of which were detailed with reference to FIGS. 4A to 4G. The visual representation itself is a model, preferably in the form of a flow diagram (such as, for example, the diagram shown in FIG. 2), made up of a number of design elements that are associated with the decision process objects of the given decision process. The visual representation indicates a flow of the steps of the decision process.

At step 102, a file generated from the design template is deployed to the client machine (e.g. client machine 40 of FIG. 1) for use by a client application. Different modes of transmission may be used, as discussed earlier in this description or as may otherwise be known to persons skilled in the art.

At step 104, the client application is loaded into the memory of a client machine. The client application performs the steps of the decision process in accordance with the design template using the file generated at step 102. In processing the decision process, output is displayed to client application users, and input may be received from client application users as defined by the decision process.

At step 106, data that is input by client application users through the client application may be analyzed. The analysis may be performed at the client machine, and the path of steps in the decision process to be followed may depend on the input received from client application users and on the results of the analysis, for example. The input may also be transmitted back to the designer machine, where designers through the designer application can analyze the input. This information can be used to track usage patterns of client application users and characteristics relating to how knowledge is being provided through the decision process, and also to update the decision process, for example. The functions at this step will typically be performed while client application is still executing (i.e. concurrently with the performance of step 104).

At step 108, a designer may optionally update the decision process by revising the associated design template, in which case, the flow of method steps proceeds back to step 102 where the updated decision process is to be re-deployed.

In variant embodiments of the invention, the database where input from client application users are stored may reside independently (e.g. outside of storage device 24 of FIG. 1), or on a machine other than the designer machine (e.g. on a computing device other than designer machine 20 of FIG. 1) that is on or coupled to the client machine (e.g. client machine 40 of FIG. 1) somewhere on the network. It will be understood by persons skilled in the art that the data to be stored in such a database may be distributed across multiple data storage devices residing on one device or multiple computing devices.

It will also be understood by persons skilled in the art that the term “memory” as used herein is not to be understood as being limited to a single memory or storage component or device. Data in memory of a computing device may be stored in a single memory device, or in multiple memory devices.

It will also be understood by persons skilled in the art that all components of a system for defining and processing decision processes in an embodiment of the present invention may reside on a single computing device, or on multiple computing devices.

The present invention has been described with regard to specific embodiments. However, it will be obvious to persons skilled in the art that a number of other variants and modifications can be made without departing from the scope of the invention defined in the claims appended hereto.

1. A method of defining and processing a predetermined decision process comprising a plurality of steps, the method comprising the steps of:
a. generating a design template for said decision process, wherein said design template is a visual representation of said decision process generated by a first computing application; and
b. processing said decision process, wherein a second computing application is adapted to execute said decision process as represented by said design template.

2. The method of claim 1, wherein said first computing application is adapted to display said visual representation to one or more first users of said first computing application, wherein a plurality of steps of said decision process can be modeled using a plurality of decision process objects, wherein said visual representation comprises a plurality of design elements associated with said decision process objects such that said visual representation indicates a flow of said steps of said decision process, and wherein said generating step also includes manipulating said design elements in a user interface of said first computing application to generate said visual representation.

3. The method of claim 2, wherein each of said decision process objects is selected from the following group: question, choice, condition, user input, category, formula, summary, conclusion, and section.

4. The method of claim 1, wherein said method further comprises the step of deploying said decision process to one or more second users of said second computing application.

5. The method of claim 1, wherein at said processing step, said steps of said decision process are performed in accordance with said flow thereof as indicated by said visual representation, wherein output is displayed to said second users as defined by said decision process, and wherein input is received from said second users as defined by said decision process.

6. The method of claim 5, wherein said method further comprises the step of storing at least a subset of said input in a database for subsequent use by said first computing application.

7. The method of claim 6, further comprising the step of displaying at least a subset of said input stored in said database at said storing step to one or more first users of said first computing application.

8. The method of claim 6, wherein input stored in said database at said storing step is used to associate a frequency identifier with each of at least one path of steps of said decision process, and to display one or more frequency identifiers to one or more first users of said first computing application.

9. The method of claim 6, wherein input stored in said database at said storing step is used to associate a response time identifier with each of at least one pair of steps of said decision process, and to display one or more response time identifiers to one or more first users of said first computing application.

10. The method of claim 1, wherein said generating step also includes defining at least one entry point, wherein each entry point indicates a step from which said steps of said decision process are to commence performance in said deploying step.

11. The method of claim 1, further comprising the step of updating said design template.

12. A system for defining and processing a predetermined decision process comprising a plurality of steps, the system comprising:
a. a first computing application adapted to generate a design template, wherein said design template is a visual representation of said decision process; and
b. a second computing application adapted to receive instances of said design template and process said decision process, wherein said decision process is executed as represented by said design template.

13. The system of claim 12, wherein said first computing application is adapted to display said visual representation to one or more first users of said first computing application, wherein a plurality of steps of said decision process can be modeled using a plurality of decision process objects, wherein said visual representation comprises a plurality of design elements associated with said decision process objects such that said visual representation indicates a flow of said steps of said decision process, and wherein said generating step also includes manipulating said design elements in a user interface of said first computing application to generate said visual representation.

14. The system of claim 13, wherein each of said decision process objects is selected from the following group: question, choice, condition, user input, category, formula, summary, conclusion, and section.

15. The system of claim 12, wherein said first computing application is adapted to deploy said decision process to one or more second users of said second computing application.

16. The system of claim 12, wherein in executing said decision process, said steps of said decision process are performed in accordance with said flow thereof as indicated by said visual representation, wherein output is displayed to said second users as defined by said decision process, and wherein input is received from said second users as defined by said decision process.

17. The system of claim 16, wherein said second computing application is further adapted to store at least a subset of said input in a database for subsequent use by said first computing application.

18. The system of claim 17, wherein said first computing application is further adapted to display at least a subset of said input stored in said database to one or more first users of said first computing application.

19. The system of claim 17, wherein said first computing application is further adapted to associate a frequency identifier with each of at least one path of steps of said decision process using input stored in said database, and to display one or more frequency identifiers to one or more first users of said first computing application.

20. The system of claim 17, wherein said first computing application is further adapted to associate a response time identifier with each of at least one pair of steps of said decision process using input stored in said database, and to display one or more response time identifiers to one or more first users of said first computing application.

21. The system of claim 12, wherein said first computing application is further adapted to permit one or more first users to define at least one entry point, wherein each entry point indicates a step from which said steps of said decision process are to commence performance.

22. The system of claim 12, wherein said first computing application is further adapted to permit one or more first users to update said design template.

23. A computer-readable medium upon which a set of software components is stored, the software components containing instructions for performing the steps in a method of defining and processing a predetermined decision process, wherein said decision process comprises a plurality of steps, the method comprising the steps of:
a. generating a design template for said decision process, wherein said design template is a visual representation of said decision process generated by a first computing application; and
b. processing said decision process, wherein a second computing application is adapted to execute said decision process as represented by said design template.
